(19) United States
(12) Patent Application Publication
(10) Pub. No.: US 2006/0103964 A1
(43) Pub. Date: May 18, 2006

(54) Variable control of write parameters for hard disk drive

(75) Inventors: Sang Hoon Chu, Santa Clara, CA (US); Kang Seok Lee, San Jose, CA (US); Jong Yun Yun, Cupertino, CA (US); Yeong Kyun Lee, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd.

(21) Appl. No.: 10/987,417

(22) Filed: Nov. 12, 2004

(51) Int. Cl. G11B 5/02; G11B 5/09

(52) U.S. Cl. 360/68; 360/46

(57) ABSTRACT

A hard disk drive that changes a variable write parameter of a head during a write operation. The controller can change the variable write parameter to compensate for a transient temperature profile of the head during the initial stage of a write operation. By way of example, the controller can provide a relatively large overshoot control signal of a head during the writing of a first sector of a write operation. The value of the overshoot control signal may be decremented for a second sector, a third sector etc., until the head attains a thermal steady state at which point the overshoot control signal is provided with a constant value.

### BACKGROUND OF THE INVENTION

1. Field of the Invention

The present invention relates to a method for writing data onto a disk of a hard disk drive.

2. Background Information

Hard disk drives contain a plurality of magnetic heads that are coupled to rotating disks. The heads can magnetize and sense the magnetic fields of the disk to write and read data, respectively. The heads are coupled to an pivoting actuator arm that has a voice coil motor.

Data is typically stored on tracks that extend radially across the disk surfaces. The voice coil motor can be energized to pivot the actuator arm and move the heads to different track locations. Each track is typically divided into a number of sectors. Each sector contains at least one data field.

The disk drive typically writes data in blocks across a number of data sectors. Data is written by providing a write current to a coil of the heads. The coil generates a magnetic flux that magnetizes the disk. The write current also generates heat that increases the temperature of the heads. It has been found that the heads may not generate a sufficient magnetic flux before attaining a certain operating temperature. Consequently the first couple of data sectors may have invalid data. It would be desirable to compensate for cold heads in a hard disk drive.

### BRIEF SUMMARY OF THE INVENTION

A hard disk drive with a controller that changes a variable write parameter of a head during a write operation.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is a timing diagram showing the change of a variable write parameter.

### DETAILED DESCRIPTION

Disclosed is a hard disk drive that changes a variable write parameter of a head during a write operation. The controller can change the variable write parameter to compensate for a transient temperature profile of the head during the initial stage of a write operation. By way of example, the controller can provide a relatively large overshoot control signal of a head during the writing of a first sector of a write operation. The value of the overshoot control signal may be decremented for a second sector, a third sector etc., until the head attains a thermal steady state at which point the overshoot control signal is provided with a constant value.

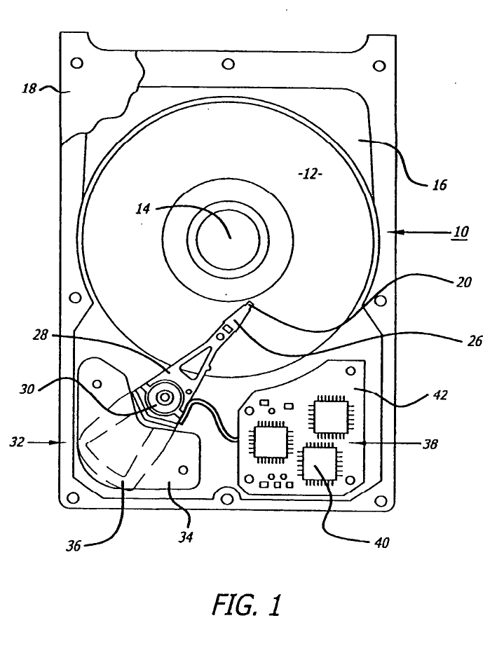

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

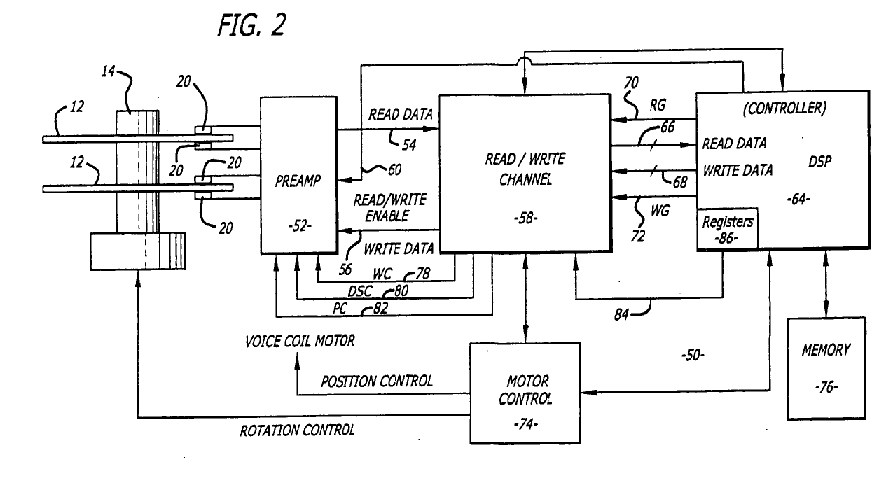

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROMN”).

The pre-amp 52 typically has a number of different write characteristics such as write current, overshoot control and pre-compensation. The values of these characteristics can be set through write current Wc 78, overshoot control OSC 80 and pre-compensation Pc 82 lines. The values may be set by the read/write channel circuit 58. The read/write channel circuit 58 may obtain the values from the controller 64 through line 84. The values may be stored in registers 86 of the controller 64. By way of example, values may be stored in 3 different registers I_xxx, F_xxx and Step_size. The I_xxx register may store the initial variable write parameter value. The F_xxx register may store the final value, and the Step_size register may store the size of the steps.

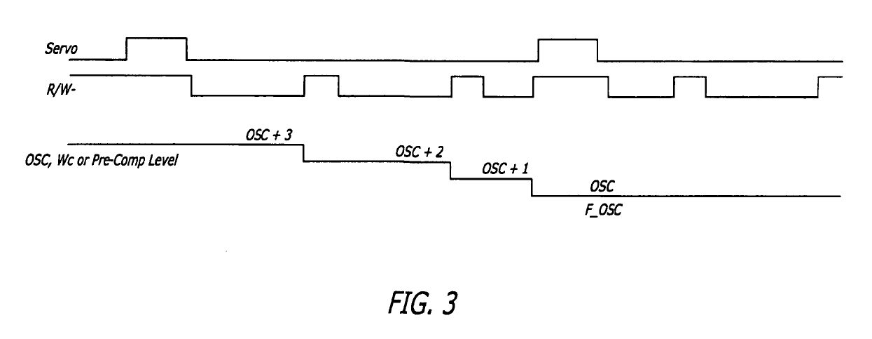

FIG. 3 is a timing diagram showing the change of a variable write parameter during a write operation. In this example, the overshoot control OSC is being changed during the write operation. The overshoot OSC is initially set to a relatively high value OSC+3 during the writing of a first data sector. The high setting compensates for the initial low temperature of the head. The initial setting may be provided by register I_xxx.

At the end of the first data sector the OSC is decremented to the value OSC+2. The step size may be provided by register step_size. The head then writes data onto a second data sector. The OSC is decremented to OSC+1 for a third data sector and then down to the value OSC for the remainder of the write operation. At this point the head has reached a sufficient operating temperature for writing data. Although a decreasing scale is shown, it is to be understood that the values may increases.

Additionally, although a step size of −1 is shown, it is to be understood that other steps sizes may be employed. The values can be changed with a hardware implementation and/or a firmware implementation of the drive.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk that has a plurality of data sectors;
a spindle motor that rotates said disk;
a head coupled to said disk;
an actuator arm coupled to said head;
a voice coil motor coupled to said actuator arm; and,
a controller coupled to said head, said controller controls a write operation onto a plurality of said data sectors, said controller changes a value of a variable write parameter of said head for said write operation.

2. The disk drive of claim 1, wherein said variable write parameter is a write current.

3. The disk drive of claim 1, wherein said variable write parameter is an overshoot control signal.

4. The disk drive of claim 1, wherein said variable write parameter is a pre-compensation signal.

5. The disk drive of claim 1, wherein said controller includes registers that contain values for said variable write parameter.

6. The disk drive of claim 1, wherein said controller decreases said variable write parameter during said write operation.

7. The disk drive of claim 1, wherein said disk includes a first sector and a second sector, said controller writes data onto said first sector with a first write parameter and writes data onto said second sector with a second write parameter.

8. A hard disk drive, comprising:
a disk that has a plurality of data sectors;
a spindle motor that rotates said disk;
a head coupled to said disk;
an actuator arm coupled to said head;
a voice coil motor coupled to said actuator arm; and,
controller means for controls a write operation onto a plurality of said data sectors, and changing a value of a variable write parameter of said head for said write operation.

9. The disk drive of claim 8, wherein said variable write parameter is a write current.

10. The disk drive of claim 8, wherein said variable write parameter is an overshoot control signal.

11. The disk drive of claim 8, wherein said variable write parameter is a pre-compensation signal.

12. The disk drive of claim 8, wherein said controller means includes registers that contain values for said variable write parameter.

13. The disk drive of claim 8, wherein said controller means decreases said variable write parameter during said write operation.

14. The disk drive of claim 8, wherein said disk includes a first sector and a second sector, said controller means writes data onto said first sector with a first write parameter and writes data onto said second sector with a second write parameter.

15. A hard disk drive, comprising:
a disk that has a plurality of data sectors;
a spindle motor that rotates said disk;
a head coupled to said disk;
an actuator arm coupled to said head;
a voice coil motor coupled to said actuator arm;
controller coupled to said head; and,
a memory that contains a program which causes said controller to control a write operation onto a plurality of said data sectors, and change a value of a variable write parameter of said head for said write operation.

16. The disk drive of claim 15, wherein said variable write parameter is a write current.

17. The disk drive of claim 15, wherein said variable write parameter is an overshoot control signal.

18. The disk drive of claim 15, wherein said variable write parameter is a pre-compensation signal.

19. The disk drive of claim 15, wherein said controller includes registers that contain values for said variable write parameter.

20. The disk drive of claim 15, wherein said controller decreases said variable write parameter during said write operation.

21. The disk drive of claim 15, wherein said disk includes a first sector and a second sector, said controller writes data onto said first sector with a first write parameter and writes data onto said second sector with a second write parameter.

22. A method for writing data onto a plurality of data sectors of a hard disk drive, comprising:
setting a variable write parameter of a head;
writing data onto a first sector of a disk with the head;
changing the variable write parameter of the head; and,
writing data onto a second sector of the disk with the head.

23. The method of claim 22, wherein the variable write parameter is a write current.

24. The method of claim 22, wherein the variable write parameter is an overshoot control signal.

25. The method of claim 22, wherein the variable write parameter is a pre-compensation signal.

26. The method of claim 22, wherein values for the variable write parameter are stored in registers.

27. The method of claim 22, wherein the variable write parameter for writing data onto the second sector is a lower value than the variable write parameter for writing data onto the first sector.
